(19) United States
(12) Patent Application Publication
(10) Pub. No.: US 2009/0161869 A1
(43) Pub. Date: Jun. 25, 2009

(54) Method for distributing encrypted digital content

(75) Inventors: Su-Woan Chow, Taipei (TW); Pong-Sheng Wang, Taipei (TW); Patrick Jamp, Taipei (TW)

Correspondence Address: BACON & THOMAS, PLLC, 625 SLATERS LANE, FOURTH FLOOR, ALEXANDRIA, VA, 22314-1176, US

(73) Assignee: NSTREAMS TECHNOLOGIES, INC., Taipei (TW)

(21) Appl. No.: 12/000,948

(22) Filed: Dec. 19, 2007

(51) Int. Cl. H04L 9/14

(52) U.S. Cl. 380/259

(57) ABSTRACT

A method for distributing encrypted digital content is disclosed in the invention. Firstly, a digital content of a source is encrypted via a symmetric key encryption mechanism by using a first public key, so as to generate an encrypted digital content; the first public key is also encrypted to generate an encryption key at the source by using a second public key via an asymmetric key encryption mechanism provided from a destination, so that the encryption key may only be decrypted by using a private key compatible with the second public key at the destination. Therefore, no matter the encrypted digital content is distributed via secure or insecure routes, the ones who are not at the destination cannot access the digital content.

### FIELD OF THE INVENTION

The invention relates to a method for distributing digital content, and more particularly to a method for distributing digital content encrypted at a source by using a public key through a symmetric key encryption mechanism, wherein the public key is then encrypted through an asymmetric key encryption mechanism provided by a destination, so as to prevent the digital content from being accessed illegally.

### BACKGROUND OF THE INVENTION

Generally, multimedia production companies such as movie studios, television stations, or advertising companies produce digital contents like films or television programs by using their own production equipment, and then have image processing companies to complete all of the subsequent procedures for the digital contents (for example, the procedures for protecting and converting the digital contents) by using a source equipment, which is then sent or transferred to various destinations, such as movie theaters, cable TV stations, or hotels with Pay-Per-View services etc. Such digital contents may be sent or transferred to the aforesaid destinations via different routes like satellites or communication networks (such as the Internet or Local Area Network), or may be stored in a physical storage device like hard disks or memory cards and transported to the aforesaid destinations via transporters. In addition, the digital contents must undergo certain security procedures during its transfer or transportation to various destinations in order to protect such digital contents from being illegally copied. In other words, in the process starting from completing all the subsequent procedures for the digital contents to transferring or transporting the processed digital contents to the destinations, security procedures are required to prevent the digital contents from being illegally copied by others.

The purpose of the aforesaid security procedures is to ensure the digital contents to be transferred or transported to the destinations via secure routes, there are currently two security procedures available, one is to transfer the digital contents to destinations via exclusive and secure communication networks, the other is to transport the digital contents to destinations by hiring private transporters, both of them are expensive. More importantly, when it becomes necessary to transfer or transport a large amount of digital contents frequently, the expenses required for the aforesaid two methods will increase accordingly along with the amount and frequency of the digital contents that need to be transferred or transported.

However, the expenses required for transferring or transporting such digital contents is counted as the basic costs that must be covered by the image processing companies, and the costs are firstly passed to each of the broadcasting agents, who in turn pass the costs to consumers who watch the films and television programs. As a result, the costs for the consumers who watch the films and television programs become relatively higher, which will make the consumers reluctant to watch the films and television programs, and consequently undermine the profit margin of the broadcasting agents and the image processing companies. Therefore, it is urgent to find a method for distributing digital contents cheaply and securely, so that the digital contents is able to be protected from being illegally copied by others during its transfer or transportation.

### SUMMARY OF THE INVENTION

In light of the disadvantages of the prior arts, a method for distributing encrypted digital content has been disclosed in the invention in an attempt to alleviate the aforesaid problems.

A primary objective of the invention is to provide a method for distributing encrypted digital content, in which a digital content is encrypted at a source by using a first public key through a symmetric key encryption mechanism, so as to generate an encrypted digital content; the first public key is also encrypted at the source to generate an encryption key by using a second public key provided by an asymmetric key encryption mechanism from a destination, so that the encryption key may only be decrypted by using a private key from the destination that corresponds to the second public key. Therefore, no matter the encrypted digital content is distributed via secure or insecure routes, the ones who are not at the destination cannot access the digital content.

### BRIEF DESCRIPTION OF DRAWINGS

The technical means adopted by the invention to achieve the above and other objectives can be best understood by referring to the following detailed description of the preferred embodiments and the accompanying diagrams, wherein:

FIG. 1 is a schematic view that shows multiple digital contents of a source are transferred to different destinations via secure or insecure routes, according to the invention.

FIG. 2 is a schematic view that shows the encryption of a digital content and a first public key according to the invention.

FIG. 3 is a flow chart that shows the steps for encrypting the digital content of the source according to the invention.

FIG. 4 is a flow chart that shows the steps for decrypting the encrypted digital content from the destination according to the invention.

### DETAILED DESCRIPTION OF PREFERRED EMBODIMENTS

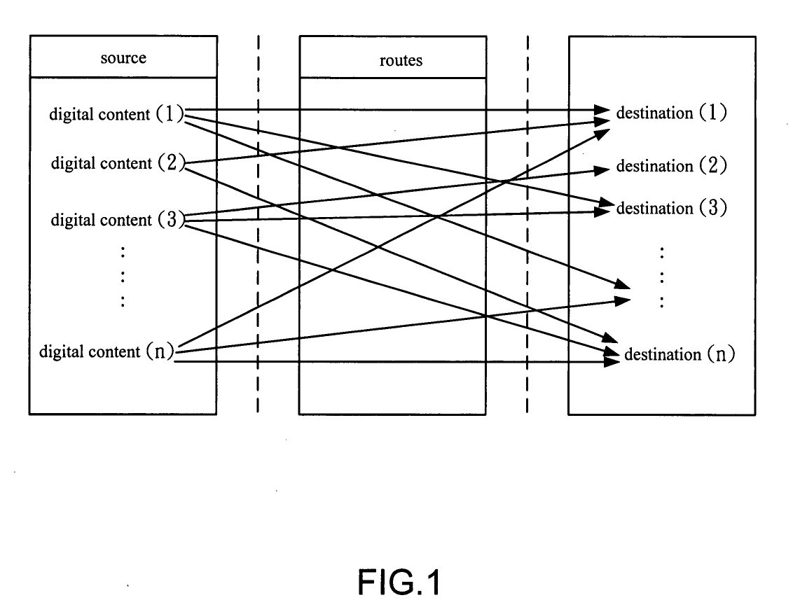

In general, to distribute digital contents (especially digital contents of great value) via secure routes to broadcasting agents in an inexpensive way, as referring to FIG. 1, while attempting to protect the digital contents from being illegally copied, it is necessary to understand that the digital contents has the following characteristics:
1. With regard to the current data transfer capability, as well as the storage capability of the current physical storage devices; the generally tolerable size of digital contents to be transferred at an acceptable speed is between several kilobytes to several gigabytes.
2. Each digital content needs to be transferred to hundreds or thousands of broadcasting agents.
3. Various digital contents may need to be stored in a single physical storage device in order to facilitate the transfer thereof to a broadcasting agent.
4. Since each broadcasting agent may demand different digital contents, it is necessary to be able to easily store the different digital contents in one physical storage device.
5. For the security of the digital contents, no one except for the assigned broadcasting agents are allowed to access the digital contents during transfer thereof, or when the digital contents are stored in the physical storage device, so that the unassigned transporters, broadcasting agents, or thieves cannot access the digital contents.
6. Because the size of digital contents may be quite large, it would take the image processing companies a lot of time for encrypting the digital contents if such contents needs to be encrypted several times, and consequently the broadcasting agents would also need to spend a lot of time on decrypting the digital contents. Therefore, it is important to transfer every single digital content without having many times of encryption to the broadcasting agents.
7. In addition to preventing digital contents from being encrypted and decrypted many times, the digital contents must not be too easy to copy, or take too much time and too much computation capability to complete encryption and decryption thereof.

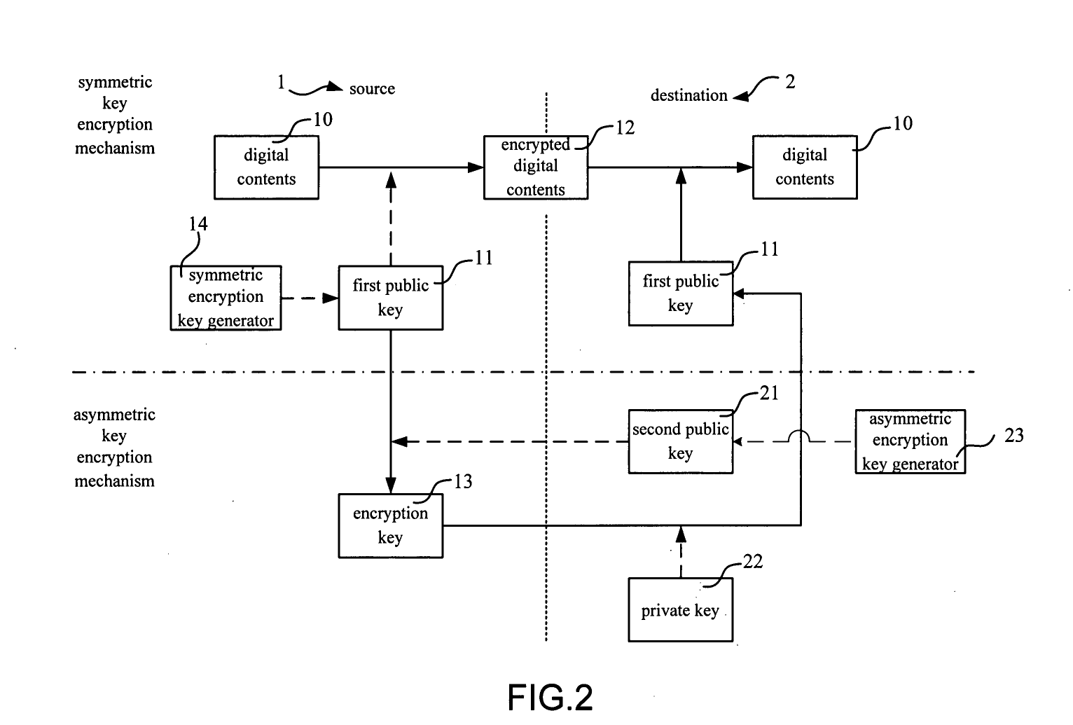

Based on technical experiences and professional know-how accumulated over the years, the inventor has proposed a method for distributing encrypted digital content in response to the aforesaid demands. Referring to FIG. 2, the method firstly encrypts a digital content 10 of a source 1 via a symmetric key encryption mechanism by using a first public key 11, so as to generate an encrypted digital content 12. Subsequently, the first public key 11 is encrypted at the source 1 by using a second public key 21 via an asymmetric key encryption mechanism provided from a destination 2, so as to generate an encryption key 13. Because the encrypted digital content 12 must be decrypted by the first public key 11, and the first public key 11 has been encrypted to become the encryption key 13; the encryption key 13 can only be decrypted by a private key 22 provided from the destination 2 that corresponds to the second public key 21. As a result, when the encrypted digital content 12 and the encryption key 13 are transferred via secure or insecure routes to the destination, anyone who is not from the destination 2 is unable to decrypt the encrypted digital content 12 even if obtaining both the encrypted digital content 12 and the encryption key 13.

In the invention, the symmetric key encryption mechanism may either be the Data Encryption Algorithm (DEA), the International Data Encryption Algorithm (IDEA), or the Advanced Encryption Standard (AES); while the asymmetric key encryption mechanism may either be the RSA Algorithm, the Digital Signature Algorithm (DSA), or the Diffie-Hellman Algorithm.

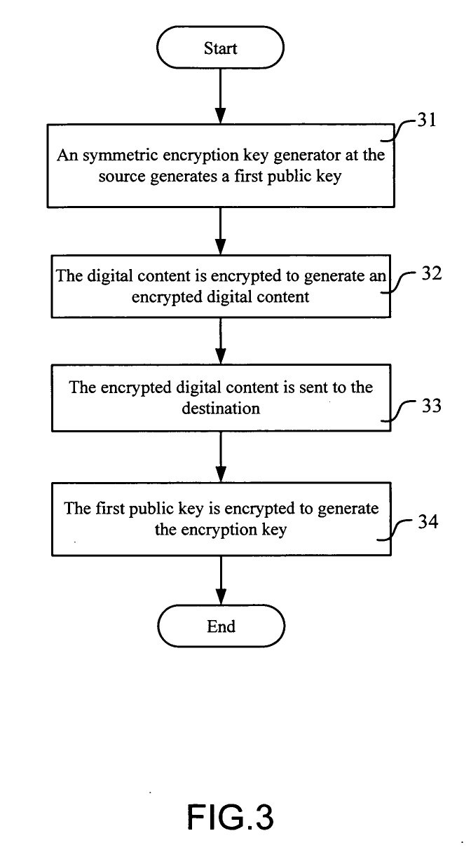

Referring to FIGS. 2 and 3, which shows the steps for encrypting the digital content of the source according to a preferred embodiment of the invention. The embodiment employs the AES as the symmetric key encryption mechanism and the RSA Algorithm as the asymmetric key encryption mechanism. The procedure for encrypting the digital content 10 by the source 1 comprises the following steps:
(31) generating a first public key 11 by using a symmetric encryption key generator 14 at the source 1; in this embodiment, the symmetric encryption key generator 14 is compatible with the AES, and thus the first public key 11 generated by the symmetric encryption key generator 14 is usable to the AES. The symmetric encryption key generator 14 and the AES may be disposed on a first server system at the source 1, and the first server system may not have to be connected to the Internet;
(32) encrypting the digital content 10 via the AES by using the first public key 11 at the source 1, so as to generate and store the encrypted digital content 12 in the source 1; in this embodiment, the encrypted digital content 12 may be stored in the first server system at the source 1;
(33) transferring the encrypted digital content 12 from the source 1 to the destination 2;

in this embodiment, the encrypted digital content 12 may be stored in the first server system, or the encrypted digital content 12 may be transferred via the Internet to the destination 2 when the first server system is connected to the Internet; on the other hand, when the first server system is not connected to the Internet, the encrypted digital content 12 may be transferred from the first server system to a first physical storage device, and then transported along with the first physical storage device to the destination 2 by a transporter, in which the first physical storage device may be a hard disk or a disc (VCD, DVD, or Blue-ray DVD); and
(34) encrypting the first public key 11 via the RSA Algorithm by using the second public key 21 provided from the destination 2, so as to generate and store the encryption key 13 in the source 1, and then transfer the encryption key 13 to the destination 2;

in this embodiment, when the first server system is connected to the Internet, the encryption key 13 may be transferred via the Internet to the destination 2; on the other hand, when the first server system is not connected to the Internet, the encryption key 13 may be transferred from the first server system to a second physical storage device, and then transported along with the second physical storage device to the destination 2 by a transporter, in which the second physical storage device may be a hard disk or a disc (VCD, DVD, or Blue-ray DVD).

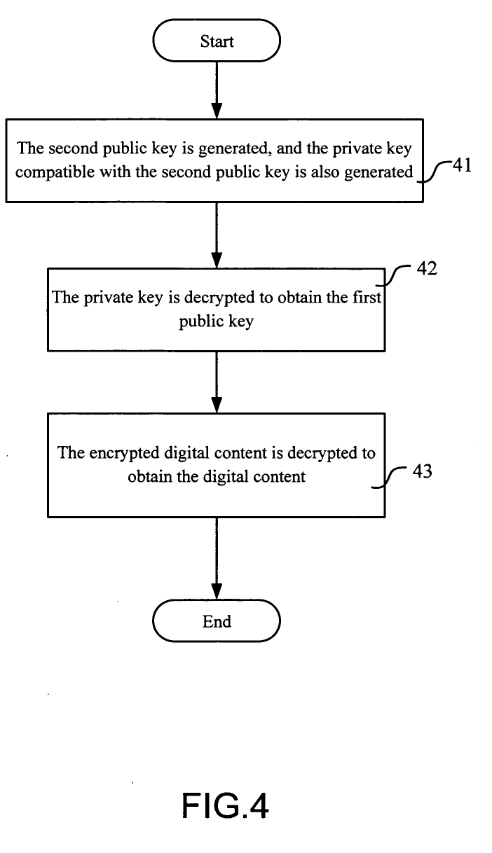

Referring to FIGS. 2 and 4, which shows the procedure for decrypting the digital content 10 at the destination 2 comprising the following steps:
(41) randomly generating the second public key 21 by using an asymmetric encryption key generator 23 at the destination 2, and generating a private key 22 that is compatible with the second public key 21, wherein the second public key 21 is transferred to the source 1 and the private key 22 is stored in the destination 2; in the embodiment, the asymmetric encryption key generator 23 is compatible with the RSA Algorithm, and thus the second public key 21 generated by the asymmetric encryption key generator 23 is usable to the RSA Algorithm. The asymmetric encryption key generator 23 and the RSA Algorithm may be disposed on a second server system at the destination 2, and the second server system may not have to be connected to the Internet. Moreover, the second public key 21 may be stored in a third physical storage device, and then transported along with the third physical storage device to the source 1 by a transporter, in which the third physical storage device may be a hard disk or a disc (VCD, DVD, or Blue-ray DVD); the private key 22 is stored in the second server system;
(42) decrypting the encryption key 13 received from the source 1 via the RSA Algorithm by using the private key 22 at the destination 2, so as to obtain the first public key 11 for storage; in the embodiment, the first public key 11 is then stored in the second server system at the destination 2; and
(43) decrypting the encrypted digital content 12 received from the source 1 via the AES by using the first public key 11 at the destination 2, so as to obtain and store the digital content 10 in the second server system; in the embodiment, the AES may be disposed in the second server system.

In the aforesaid procedures, both the first server system and the second server system comprise at least one server, and the symmetric encryption key generator 14 and the AES are disposed in either separate servers or in an identical server under the first server system. Furthermore, the asymmetric encryption key generator 23 and the RSA Algorithm are disposed in either separate servers or in an identical server under the second server system. The servers are interconnected to form the first server system and the second server system respectively. In addition, when the first and the second server systems are not connected to the Internet, the encrypted digital content 12, the second public key 21, and the encryption key 13 may be separately stored into different physical storage devices, and then transported to the destination 2 or the source 1 via transporter respectively. The implementation of the aforesaid procedures gives rise to the following advantages:
a. During the transfer or transportation of digital contents via insecure routes, the encrypted digital content 12 cannot be decrypted even if the encrypted digital content 12 and the encryption key 13 were obtained by unassigned recipients or were transferred to anywhere other than the destination 2. This is because the encryption key 13 cannot be used to decrypt the encrypted digital content 12 unless it has been decrypted with the private key 22 to obtain the first public key 11 beforehand, and the private key 22 is stored at the destination 2. Therefore, even if someone has obtained the encrypted digital content 12 and the encryption key 13, he cannot access the digital content 10 unless he is at the destination 2.
b. Since the encryption of the digital content 10 and the decryption of the encrypted digital content 12 are carried out by the use of the symmetric key encryption mechanism, it does not require much computation capability for the encryption and decryption processes, which in turn significantly reduces the time it takes for completing the encryption and decryption processes, and this greatly facilitates the encryption and decryption of the digital content 10 of large size (for example, movies of high picture quality).
c. It may be necessary to transfer multiple digital contents 10 from the source 1 to different destinations 2 (as shown in FIG. 1), but each digital content 10 only needs to be encrypted once. As shown in FIG. 2, the digital content 10 of the source 1 only needs to be encrypted once to generate the encrypted digital content 12 for transferring to the destination 2, while the encrypted digital content 12 only needs to be decrypted once in order to access the digital content 10 at the destination 2. Similarly, this greatly facilitates the secure transfer of the digital content 10 of large size (for example, movies of high picture quality).
d. In case the private key 22 is damaged or lost, and the encrypted digital content 12 cannot be decrypted at the destination 2 as a consequence, it is not necessary to repeat all of the aforesaid steps for encryption and decryption. To access the digital content 10, it is only necessary to use the asymmetric encryption key generator 23 at the destination 2 to generate a new private key 22 and a new second public key 21, followed by encrypting the first public key 11 again in order to generate and transfer a new encryption key 13 to the destination 2. In other words, it is only necessary to repeat steps (41) to (43), and the digital content 10 needs not be encrypted again.

In summary, the advantages of the invention ensure the security of the digital content 10 during encryption, decryption, and distribution thereof, while also allowing the digital content 10 (especially digital content 10 of great value) to be inexpensively distributed via secure or insecure routes to broadcasting agents, which effectively protects the digital contents from being illegally copied by others.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method for distributing encrypted digital content between a source and at least a destination, wherein the source has at least a digital content, and the source distributes the digital content to the destination by using the steps of:
encrypting the digital content of the source via a symmetric key encryption mechanism by using a first public key so as to generate an encrypted digital content, and transferring the encrypted digital content to the destination;
encrypting the first public key to generate an encryption key at the source by using a second public key via an asymmetric key encryption mechanism provided from the destination, and transferring the encryption key to the destination;
decrypting the encryption key at the destination via the asymmetric key encryption mechanism by using a private key that corresponds to the second public key, so as to obtain the first public key; and
decrypting the encrypted digital content at the destination via the symmetric key encryption mechanism by using the first public key, so as to obtain the digital content.

2. The method of claim 1, wherein the symmetric key encryption mechanism is selected from Data Encryption Algorithm (DEA), International Data Encryption Algorithm (IDEA), or Advanced Encryption Standard (AES).

3. The method of claim 1, wherein the asymmetric key encryption mechanism is selected from RSA Algorithm, Digital Signature Algorithm (DSA), or Diffie-Hellman Algorithm.

4. The method of claim 1, wherein the procedure of encrypting the digital content by the source comprises:
randomly generating the first public key by a symmetric encryption key generator at the source;
encrypting the digital content via the symmetric key encryption mechanism by using the first public key, so as to generate and store the encrypted digital content at the source;
transferring the encrypted digital content to the destination; and
encrypting the first public key to generate the encryption key by using the second public key via the asymmetric key encryption mechanism provided from the destination, and transferring the encryption key to the destination.

5. The method of claim 4, wherein the symmetric encryption key generator is compatible with the symmetric key encryption mechanism, and the first public key generated by the symmetric encryption key generator is usable to the symmetric key encryption mechanism; the symmetric encryption key generator and the symmetric key encryption mechanism may be disposed in a first server system at the source.

6. The method of claim 5, wherein the encrypted digital content is stored in the first server system.

7. The method of claim 6, wherein the encrypted digital content is transferred from the first server system to a first physical storage device for storage.

8. The method of claim 5, wherein, when the first server system is connected to the Internet, the encryption key and the encrypted digital content is able to be transferred to the destination via the Internet.

9. The method of claim 5, wherein the encryption key is stored in the first server system.

10. The method of claim 9, wherein the encryption key is transferred from the first server system to a second physical storage device for storage.

11. The method of claim 4, wherein the procedure of decrypting the encrypted digital content at the destination comprises:
randomly generating the second public key by an asymmetric encryption key generator at the destination, as well as generating the private key compatible with the second public key, wherein the second public key is transferred to the source, and the private key is stored at the destination;
decrypting the encryption key received from the source via the asymmetric key encryption mechanism by using the private key, so as to obtain and store the first public key at the destination; and
decrypting the encrypted digital content received from the source via the symmetric key encryption mechanism by using the first public key at the destination, so as to obtain and store the digital content at the destination.

12. The method of claim 11, wherein the asymmetric encryption key generator is compatible with the asymmetric key encryption mechanism, and the second public key generated by the asymmetric encryption key generator is usable to the asymmetric key encryption mechanism.

13. The method of claim 12, wherein the asymmetric encryption key generator and the RSA algorithm are disposed in a second server system at the destination.

14. The method of claim 13, wherein the second public key is stored in a third physical storage device.
